(19) United States
(12) Patent Application Publication
(10) Pub. No.: US 2002/0169804 A1
(43) Pub. Date: Nov. 14, 2002

(54) System and method for storage space optimized memorization and generation of web pages

(76) Inventors: Fridolin Faist, Oberwolfach (DE); Thomas Gros, Neustadt (DE)

Correspondence Address: FAY KAPLUN & MARCIN, LLP, 15O BROADWAY, SUITE 702, NEW YORK, NY, 10038, US

(21) Appl. No.: 10/079,165

(22) Filed: Feb. 20, 2002

(30) Foreign Application Priority Data
Feb. 21, 2001 (DE) 101 08 258.4
Oct. 24, 2001 (DE) 101 52 566.4

(51) Int. Cl. G06F 15/00

(52) U.S. Cl. 707/513

(57) ABSTRACT

The invention relates to a system and a method for storing web page templates defined in a page description language such as HTML in process devices, and to the generation of a plurality of different web pages on the basis of a single stored template designed in a page description language such as HTML. As process devices, in particular level measuring devices, pressure measuring devices, limit switches, field devices, sensors, actuators and interface converters with a device-inherent web server including a data memory, have to be categorized. The invention moreover relates to user-definable web page templates, which can be simply modified in a desired manner by a user while in particular reducing storage space. The modifications are in particular supposed to adapt the representations based on the stored web page template on a display such as a monitor, to the specific requirements of a user or viewer. It also relates in particular to web page templates containing one or several wildcards or keywords.

### TECHNICAL BACKGROUND

The present invention relates to a system and a method for storing web page templates defined in a page description language (PDL) such as HTML, in processing units, and to the generation of a plurality of different web pages on the basis of a single memorized template composed in a page description language such as, for example, HTML. The invention in particular relates to a web page template that is defined in a page description language and is intended for being stored on a web server of a processing unit. As processing units, specifically level measuring devices, pressure measuring devices, limit switches, field devices, sensors, actuators and interface converters having a device-inherent web server including a data memory, have to be categorized.

Moreover, the invention also relates to user-definable web page templates that can be modified by a user according to his needs, in a simple manner and, in particular, in a manner reducing the storage space requirements. The modifications are in particular supposed to adapt the representations shown on a display, such as a monitor, and based on the stored web page template, to the specific requirements of the user or viewer. Finally, the invention relates to systems, methods and devices for the storage space optimized memorization of web page templates in a processing unit. In particular, it relates also to web page templates comprising one or more wildcard/s or keywords.

Due to the continuous expansion of both the Ethernet and the Internet in the office domain with all its known advantages, the manufacturers of industrial plants, in particular of process controls, feel compelled to use these wide-spread tools. The manufacturers thereby pay special attention to the development of device-inherent web servers, i.e. web servers integrated into processing units. Typically, these web servers are operated with fixed stored web pages, so that users disposing of the necessary infrastructure can cause a set of status information to be displayed by any web browser.

### COPYRIGHT NOTICE

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### SUMMARY OF THE INVENTION

The inventive systems offer the user the possibility of compiling individual information from the system. In a further development, these individual HTML pages can be expanded with linguistic elements—in the following also referred to as keywords—which are interpreted and replaced during the operating time by the device-inherent web server. Therewith, it is possible, to display, for example, current measured values. Yet, it is in particular also possible to only display certain measured values desired by the respective target group. This, however, entails a quite considerable requirement of non-volatile memory, since all of the templates concerned have to be individually stored in a page description language such as the HTML code.

When, for example, several field devices such as control units, sensors and/or actuators (level measuring devices, pressure measuring devices, limit switches, etc.) are connected to so-called evaluation devices, then it is possible with the above described systems to only display certain or all measured values. As an example for evaluation units, the series 500 and 600 of the devices distributed under the trademark VEGAMET® have to be mentioned here. Exemplary reference is made to the device VEGALOG® 571 as the central evaluation unit. Between these evaluation units and the central evaluation unit, respectively, and a thereto connected polling means such as a PC, notebook or such like, an interface converter is interconnected, which can also be used as a web server. Such a device is, for example, known under the trademark VEGACOM®. By means of such a device, the measured values of the connected field devices are made available in the Ethernet network or the Internet network in the HTML format.

Basically, it has hence to be stated that processing units in general such as a field device, hence a level measuring device, a pressure sensor, etc., or the central evaluation units or evaluation devices of the aforementioned kind, can also work as web servers.

The web page basically is invoked as follows. A web browser establishes a connection to the web server and requests same to transmit a certain HTML file. The web server searches its data memory (e.g. a hard disk, EPROM, flash) for the HTML file and transmits same to the browser. In this general procedure for making HTML pages available, the HTML file will not be scored, and therefore it is not possible to transmit process data to the browser. Each information for the browser has to be stored in a separate HTML file. In fact, there already exist well-known methods for dynamic contents of web pages such as CGI programs or data bases which are use in the Internet world, these methods; however, cannot be used for processing units, since in these, neither enough computing capacity and memory is available, nor are the necessary programs available.

According to an aspect of the invention, a novel method for making HTML pages with a dynamic content available in processing units provides that a web browser establishes a connection to the web server and requests same to transmit a certain HTML file. The web server searches its data memory for the memorized HTML template. In contrast to the aforementioned method, however, the web server now performs a so-called interpretative program that replaces predefined keywords from the HTML template by current values from a data base, and generates HTML codes. This newly gained file is then transmitted to the browser. By means of this method of interconnecting an interpreter, the data of the stored HTML template are completed by the data from the data base, and are then made available to the browser. Therewith, it is for the first time possible to access from the browser to the current data of the processing units, and even with means which are still reasonable to be built into processing units with respect to the costs, i.e. only a cost-efficient processor and little memory capacity are required. In this method or system, it is in fact possible to load newly generated HTML files, so that a customer can compile individual data from the system. The design possibilities, however, are still limited, and many web pages have to be stored; a fact which necessitates quite a considerable requirement of non-volatile memory, which, however, cannot be made available in greater amounts in processing units, also with respect to the costs.

According to another aspect of the invention, in a PDL template (PDL=page description language) stored on a web server, at least one wildcard is accordingly provided. This wildcard is replaced by a parameter value, which is transmitted along by the web browser upon requesting the web page. This parameter value can be fixed by the user. The parameter value hence determines the content of the web page represented by the web browser on the basis of the stored template, since the template is modified according to the delivered parameter value.

It is hence for the first time possible that a user, with his requesting a web page exerts influence with the help of the web browser on the web page actually transmitted to him, in that he delivers a parameter value along with his request, and thereby generates a new template based on the stored template, yet modifying same. Despite the manifold modification possibilities, however, only one single stored web page template (in particular HTML file) has to be stored in the web server. Therewith, the number of the templates to be stored on a web server is reduced to a minimum according to the invention. The delivered parameter value thereby represents the representation of a stored template desired by the user.

An embodiment of the invention provides that a parameter is comprised of a parameter name and a parameter value. In the template requested by the browser, everywhere, where the wildcard is identical with the parameter name, the wildcard will be replaced by the delivered parameter value. A new template is thereby generated modified in the form desired by the user and resulting in a new representation of the web page.

As already outlined before, several parameter values can also be delivered with the call of a web page so as to generate, based on the stored template, a new template modified in various points, which will then be transmitted to the browser. Various wildcards in the stored template hence will be replaced by various parameter values. For this purpose, several parameters comprised of a parameter name and a parameter value are delivered to the web server by the browser.

In general, it has to be stated that for the first time, one or more wildcard/s is/are integrated in a template (HTML file) stored on a web server, which will be replaced by parameter values that can be predefined by the user. Due to the replacement of these wildcards by the user-defined parameter value, the displayed web page is influenced according the user's wish, in particular only certain measurement points are displayed and not all of them.

As already outlined before, it is possible that the stored template also contains keywords, which will be replaced by data from a process map, i.e. by current process or measured values. This replacement of the keywords by current data from the process map ensues by means of a so-called interpreter. More details hereto can be found in that part of the Figure description referenced “Interpreter”.

A preferred embodiment of the invention provides that the replacement of one or more wildcard/s in the template stored on the web server takes place prior to the replacement of the keywords.

Basically, a web server is present, in particular in a processing unit, comprising in a data memory a predetermined number of so-called templates in a page description language. This web server can be connected with a user-operated web browser via a data communication such as, for example, the Ethernet or the World Wide Web or in any other way. The web browser serves the purpose of requesting and representing the invoked web pages, an indicator device in the form of a display or a PC monitor naturally forming part of it. For the first time, a certain web page is now called by the user by means of a browser; however, one or more parameter/s are transmitted along to the web server. In the web server, the requested template is read, and one or more wildcard/s present in the template are replaced by the respective parameter values delivered. Thereupon, this newly generated template is transmitted to the web browser.

Optionally, prior to the transmission to the web browser, an interpreter is set to run, which in the above-mentioned way replaces keywords in the newly generated, hence parameter values containing template by current values from a data base, and generates in turn a new template in the page description language. Hereby, it is then possible to carry out modifications in the way desired by the user, and to represent at the same time current values in the way desired by the user.

This approach offers the possibility of generating with only one stored template, e.g. having a size of two kilobytes, almost any desired number of web pages.

Moreover, it is also possible to deliver several parameters and to thereby change also navigation bars or other parts of the web page, and not only the representation of measurement points.

In summary it has to be noted that according to the invention, a user is for the first time enabled to adapt a processing unit including a web server and data memory to the way which is most appropriate for him. This adaptation is in particular effected by transmitting web page templates defined in a page description language via a data telecommunication to a processing unit. These templates, also referred to as PDL files are stored there, and are ready for being invoked by a web browser. Therewith, it is up to a user which web page templates have to be represented on a processing unit to be used by him, a fact which results in a storage space optimization, since the web servers and the corresponding associated data memories of such processing units can only be equipped with data storage and data processing means, as well as server means, as cost-efficient and simple as possible.

According to another aspect, it is now possible to provide the PDL templates stored on such a data memory of a processing unit with so-called keywords, which will then be replaced by means of an above mentioned interpreter by current measured values. The measured values may also contain process data or such like.

A further aspect of the invention provides that a PDL template contains wildcards which will be replaced by parameter values, which in turn are transmitted by a user with the call of the template by means of a web browser. Therewith, a single template can be used for the generation of most diverse web pages in a minimum-store manner. The modification ensues according to the user's wishes by the selection of the parameter value. Thus, the user has the possibility of activating one single template so as to invoke only measured values of a determined group of level measuring devices.

Finally, it has still to be pointed out that the features of the templates and arrangements, as well as of the methods described in detail before and hereinafter, can be combined with each other individually or in groups without any problems. Such modifications are within the scope of protection of the invention.

### BRIEF DESCRIPTION OF THE DRAWINGS

For the better understanding and for the further explanation, several advantageous embodiments of the invention will be described in the following with reference to the attached drawings. Therein shows:

FIG. 1 a schematic representation of a general method for making available web pages based on HTML templates,

FIG. 2 a schematic representation of a method for making available in processing units web pages based on HTML templates and having a dynamic content,

FIG. 3 including parts 1-7 a schematic flow chart for generating a new HTML file for representing current measured values by means of keywords,

FIG. 4 including parts 1 and 2 the measured value table according to the HTML file shown in FIG. 3 represented on the monitor

FIG. 5 including parts 1 through 3 a schematic flow chart for generating a new HTML file for representing current measured values by means of keywords, whereby only one determined range of measured values is considered,

FIG. 6 the measured value table according to the HTML file shown in FIG. 5 represented on the monitor

FIG. 7 a schematic representation of a method for making web pages based on HTML templates available, including transmission of parameters and dynamic content,

FIG. 8 including parts 1-4 a schematic flow chart for generating a new HTML file for representing user-defined representations of current measured values by means of parameter transmission and keywords according to the representation of FIG. 7,

FIG. 9 the measured value table according to the HTML file shown in FIGS. 7 and 8 represented on the display,

FIG. 10 the measured value table according to the approach illustrated in FIG. 7 represented on the monitor in a call modified as compared to FIG. 8,

FIG. 11 the measured value table according to the approach illustrated in FIG. 7 represented on the monitor in a call with the navigation bar modified as compared to FIG. 8,

FIG. 12 the navigation bar represented on the monitor, which is modified as compared to that of FIG. 11 by a corresponding call of the user.

FIG. 13 a schematic representation of a task processing system;

FIG. 14 a detail representation of individual components of the system as per FIG. 13;

FIG. 15 a schematic representation of a first inventive embodiment of a task processing system;

FIG. 16 a detail representation of individual components of the system as per FIG. 15;

FIG. 17 a schematic partial representation of a second inventive embodiment of a task processing system;

FIG. 18 a schematic partial representation of a third inventive embodiment of a task processing system;

FIG. 19 a schematic partial representation of a fourth inventive embodiment of a task processing system;

FIG. 20 a flow chart of the selection of the access path for templates during user inputs;

FIG. 21 a flow chart for generating web pages on the basis of templates; and

FIG. 22 a flow chart of sending information according to pre-configured time criteria.

### DESCRIPTION OF PREFERRED EMBODIMENTS OF THE INVENTION

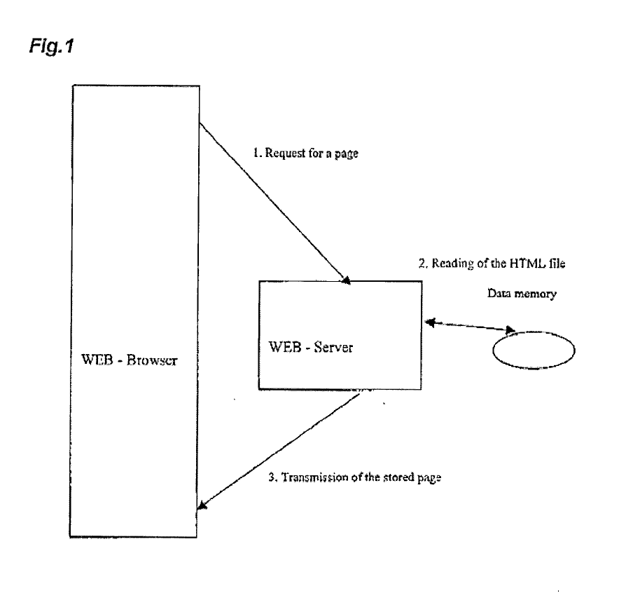

As illustrated in FIG. 1, a web server present in a processing unit is accessed via a web browser, and an HTML template stored in a data memory of the web server is invoked. This invoked HTML template or HTML file is transmitted to the web browser, and is displayed by a display not shown here to a user who has initiated the request via the web browser.

Since this file will not be scored, it is not possible to transmit process data to the web browser. In this embodiment shown in FIG. 1, each information for the browser has to be stored in a separate HTML file.

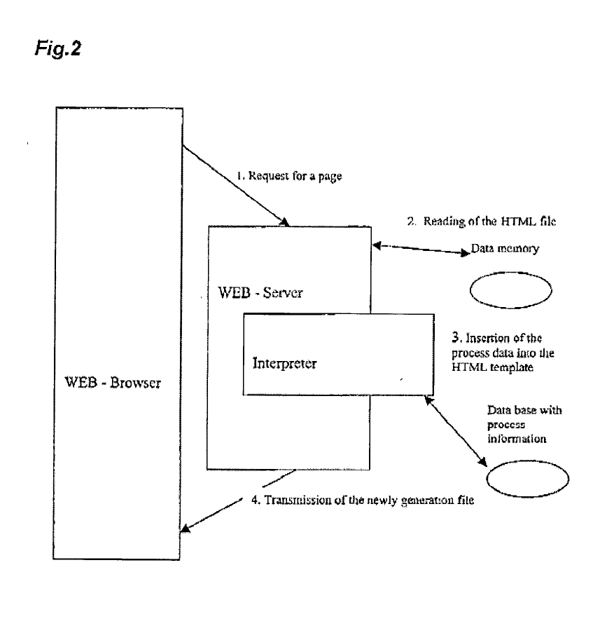

In modification to the approach illustrated in FIG. 1, an interpreter is interconnected in the embodiment shown in FIG. 2. Here, the web browser establishes a connection to the web server and requests same to transmit a determined file. The web server searches its data memory for the respective HTML template. The server now carries out an interpretative program that replaces predefined keywords of the HTML template by current values from the data base and generates HTML codes, i.e. generates a new HTML file. This newly generated HTML file is then further transmitted to the browser. In other words, the interpretative program, which is written, for example, in the programming language C, “scans” the template relative to the fixed keywords. As soon as a keyword is detected, it will be replaced by the allocated values stored in a memory or just invoked. The template itself remains an HTML file.

For the first time, the information of an HTML template is completed using an interpreter by the information from a data base, and is then made available to the browser. In the data base, the current process data such as, for example, filling level height, pressure, etc., are made available. Thus, it is possible by means of the browser to access the current data of the processing units.

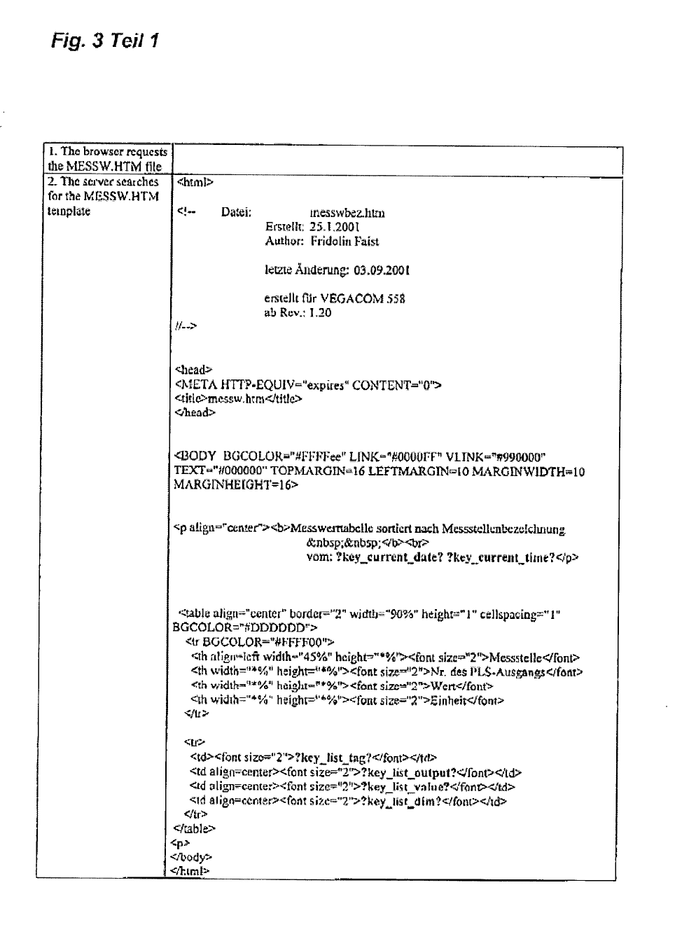

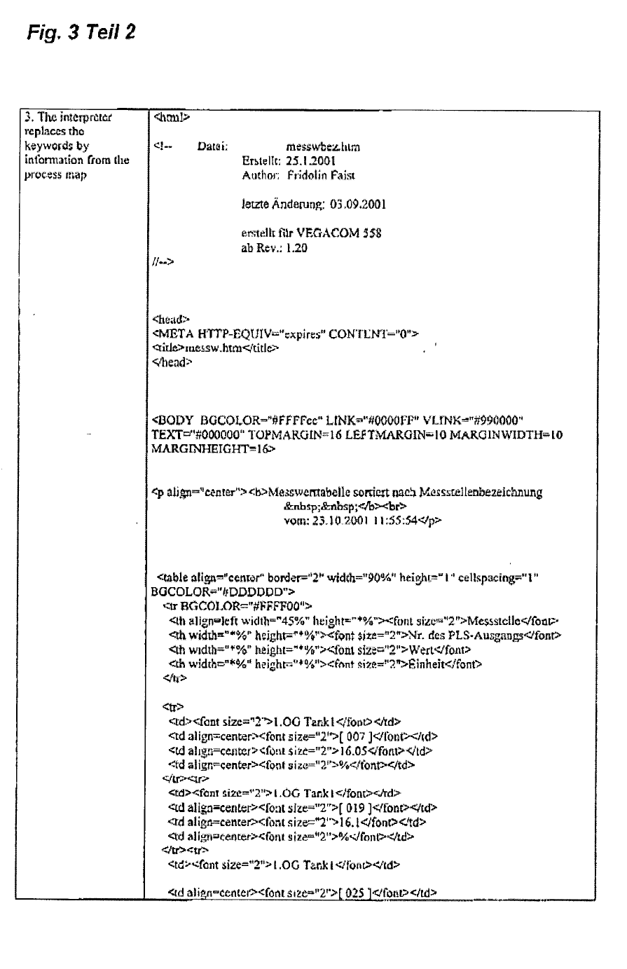

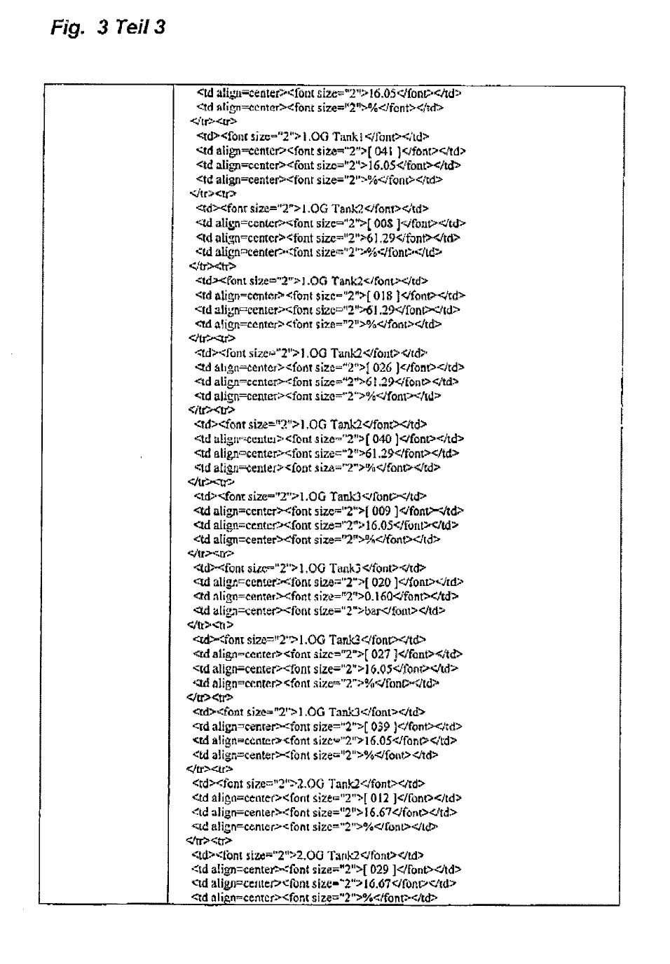

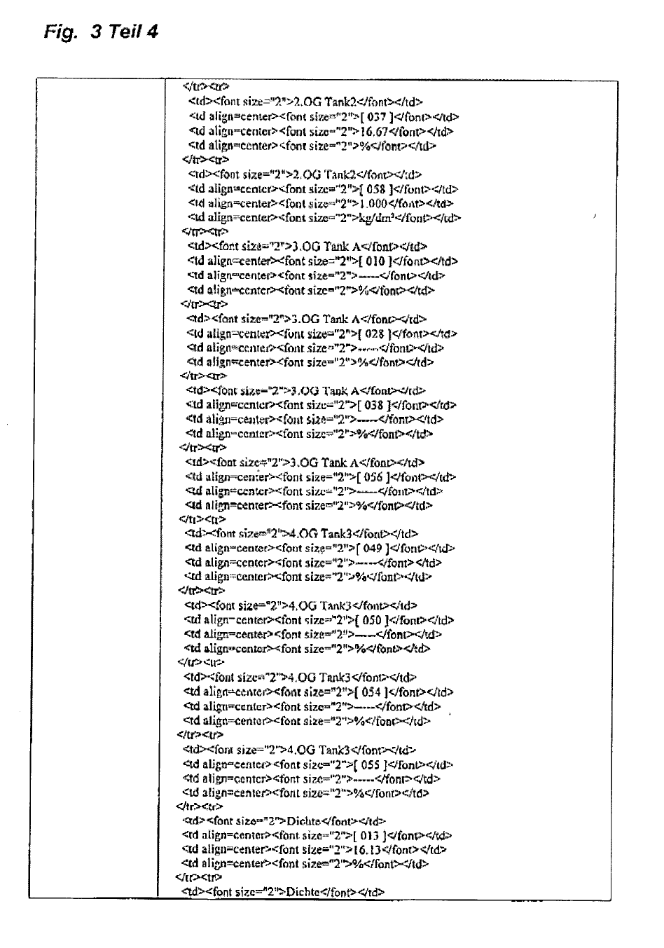

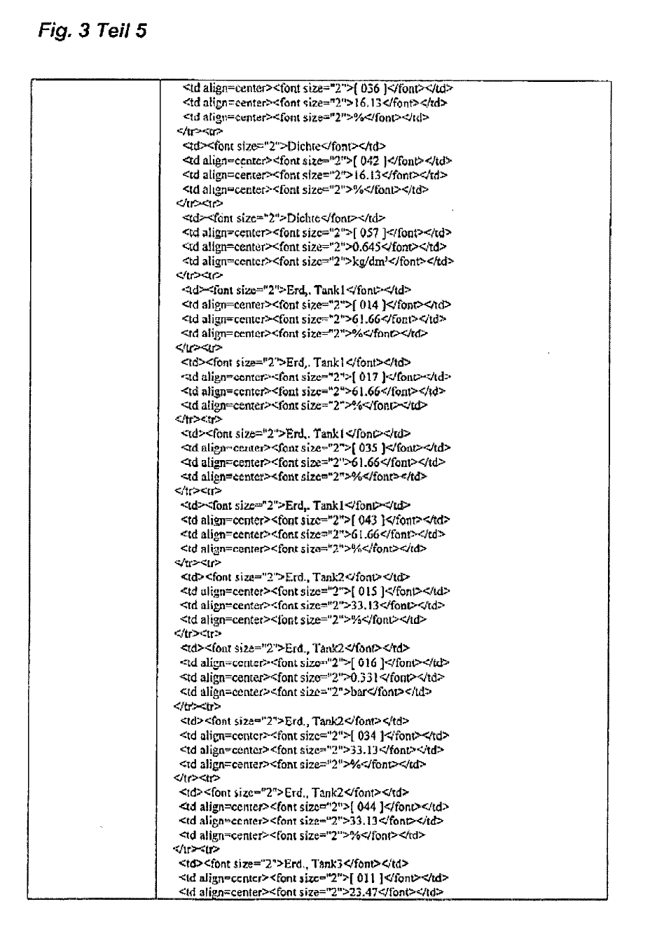

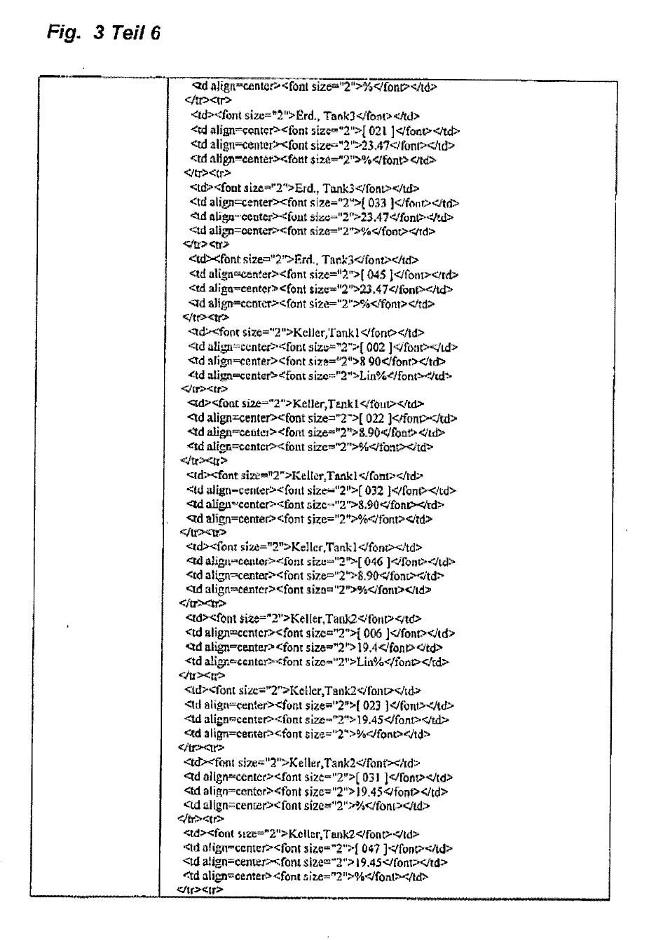

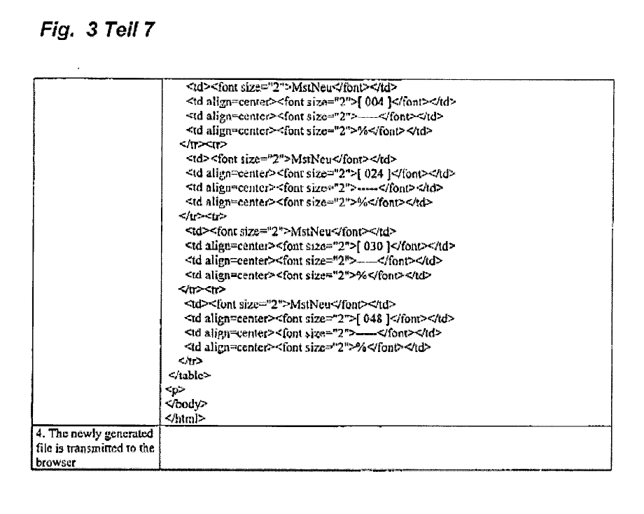

In FIG. 3 including the parts 1 through 7, the embodiment schematically illustrated in FIG. 2 can be seen in detail. According to step 1, the browser thus requests the file “messw.htm” (“measurementvalue.htm”). In step 2, the server searches the template with this name. This HTML template contains so-called keywords, such as, for example, ?key_current_date?, ?key_current_time? and ?key_list_tag?, etc., which are printed in bold letters in part 1 of FIG. 3. In step 3, the interpreter inter alia replaces the aforementioned keywords by information from the process map, and a new HTML file is generated now containing the current values. This newly generated file, which is based on the stored HTML template, is transmitted to the browser in step 4.

In step 4, it is now depicted what this measurement value table according to the HTML file generated in step 3 of FIG. 3 actually looks like. As can be seen here from (part 1 and part 2), all measurement points and the current values of these measurement points are displayed.

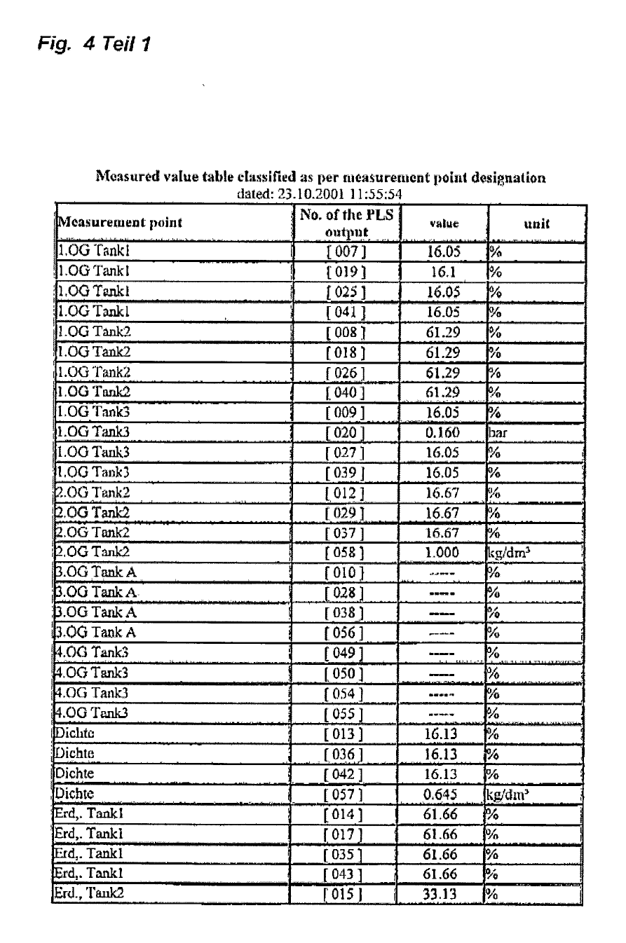

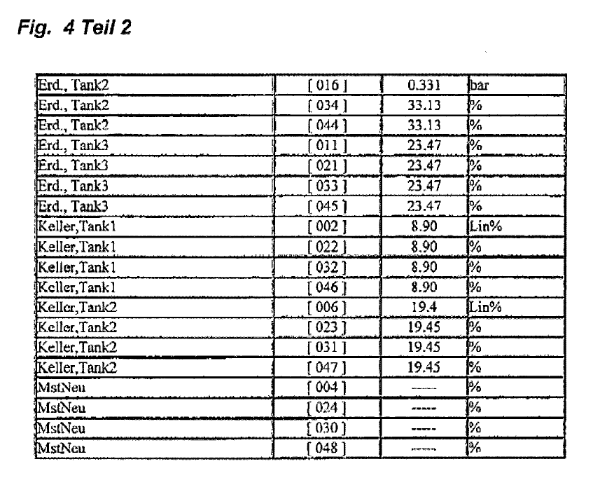

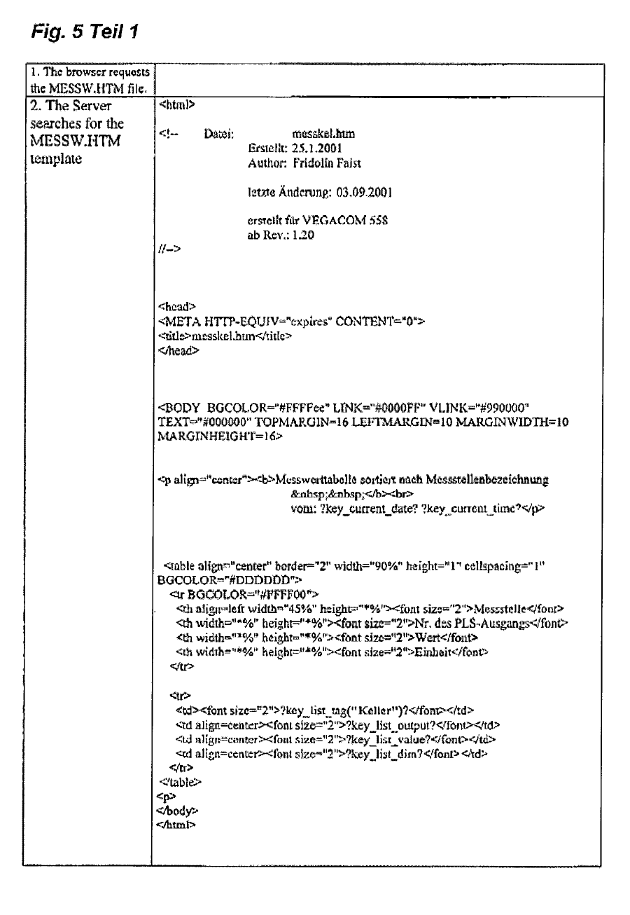

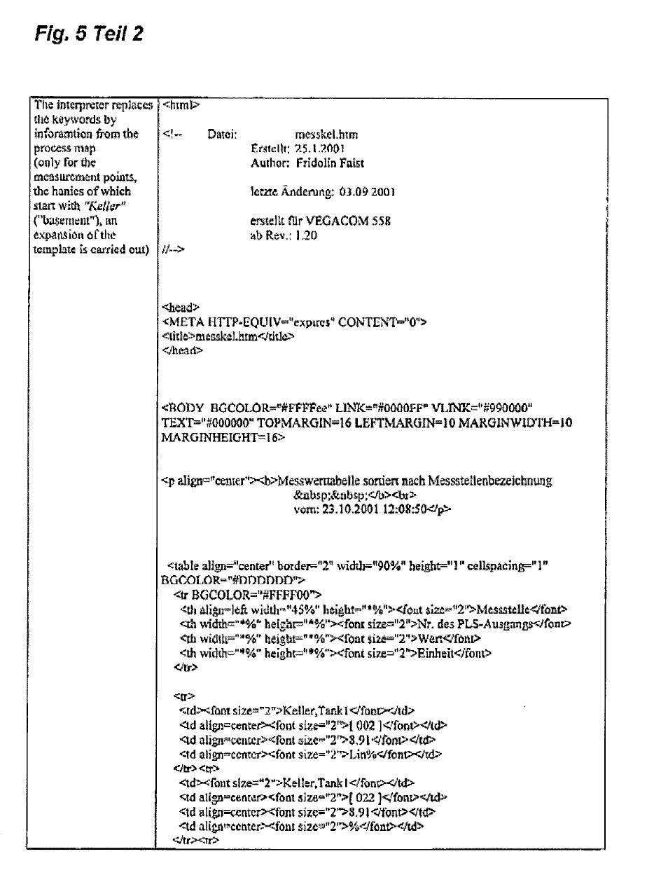

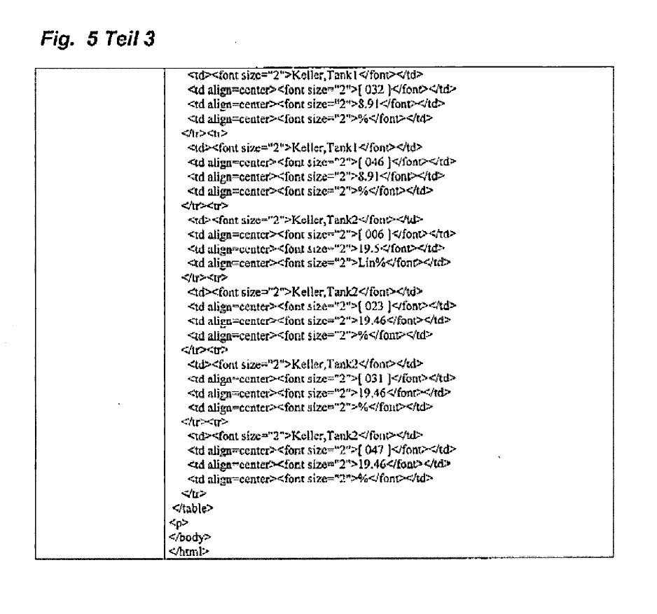

In FIG. 5 including the parts 1 and 2, a modification of the method as per FIGS. 2 through 4 is shown. Here, in the keyword ?key_list_tag?, a range limitation in the form of the word “Keller” (“basement”) is present, which is representative of determined measurement points, hence the measurement points situated in a basement. In step 3, a new HTML file (cf. file as per step 3) is then generated from the HTML template stored in the memory of the web server. Therein, all measurement points, the name of which begins with “Keller” (“basement”), are now contained.

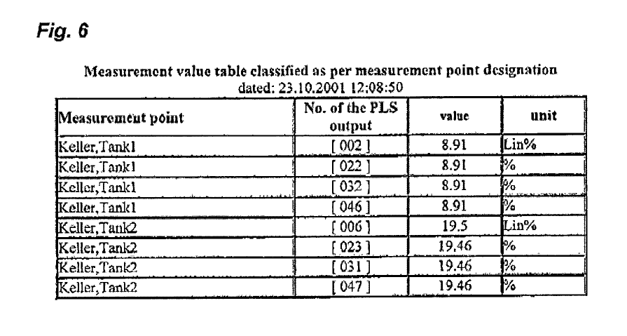

It is shown in FIG. 6 what the representation on a monitor of this “basement” measured value table looks like. It has to be emphasized that this “basement” HTML template needs to be stored on the web server. The advantage of this stored HTML template is that only user-relevant information is still displayed in a clearly arranged manner. Herewith, it is now possible to obtain partial information for the display in the browser grouped according to the most diverse criteria (e.g. location of the plant, address of a device or designation of the measurement point). Yet, it is disadvantageous that for each limitation, a separate template has to be established. This means that for each group of information, a separate template is established occupying the memory present in the processing units which in most cases is only of a minor capacity, and requiring with multi-language apparatuses to be kept available in each country's language.

In the specific case of VEGAMET devices (single evaluation units with up to seven measured values), 45 templates in three different languages would have to be stored in toto for the maximum expansion of 15 devices. Even with the small storage space requirement of about 2 KByte per template, this would result in a total requirement of 90 KByte. Since the memory present for web pages on the web server (VEGACOM 558) is restricted to 300 KByte, one third of the memory would be required with this method alone for this display.

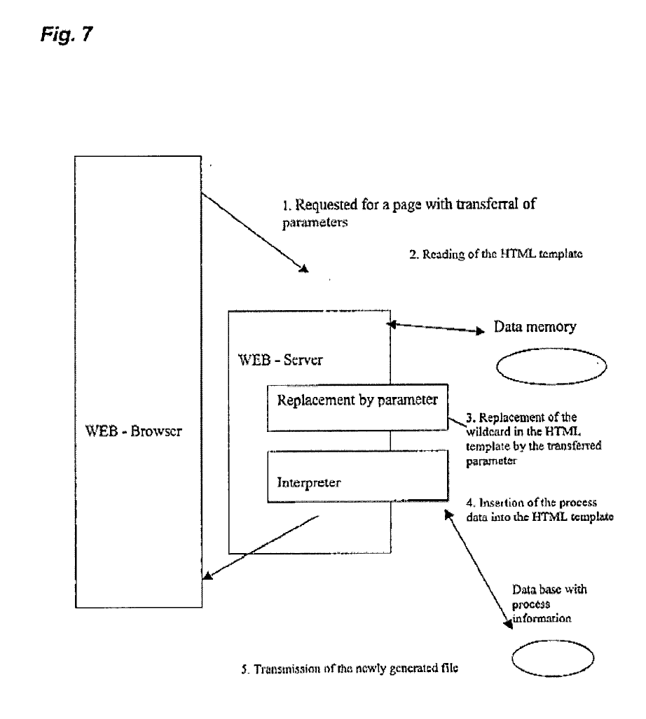

A completed variant of the aforementioned method is illustrated in FIG. 7. Here, a connection to the web server is established via the web browser. The web browser requests the web server to transmit a determined file and simultaneously delivers a parameter (comprised of parameter name and parameter value) for determining the content of the desired file. The web server searches its data memory for the respective HTML template and replaces first the wildcard/s in the HTML template by the delivered parameter value. For this purpose, the parameter name has to correspond to the wildcard.

After this, the interpretative program is carried out in the manner explained above, replacing the predefined keywords from the template by current values from the data base, and generating a new HTML file. This newly generated file is then further transmitted to the browser.

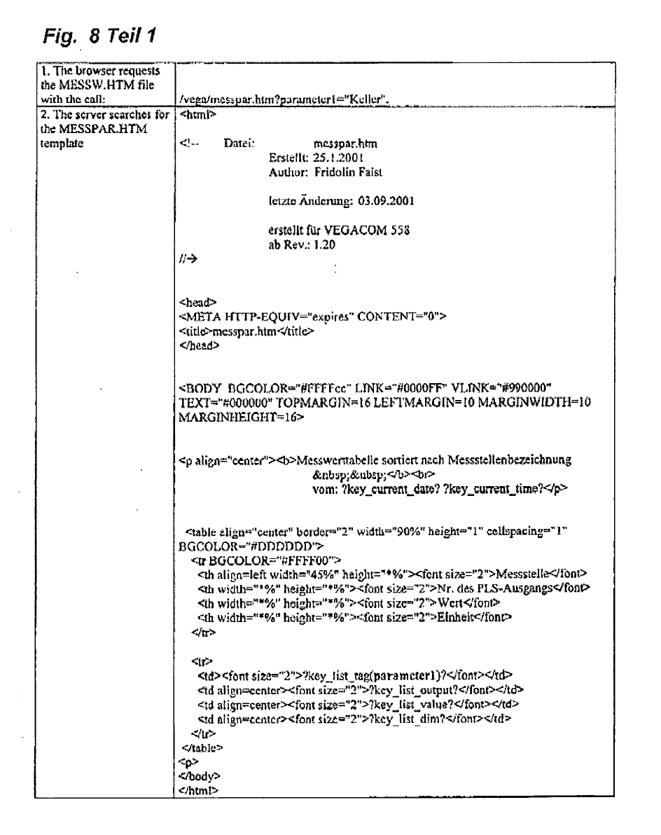

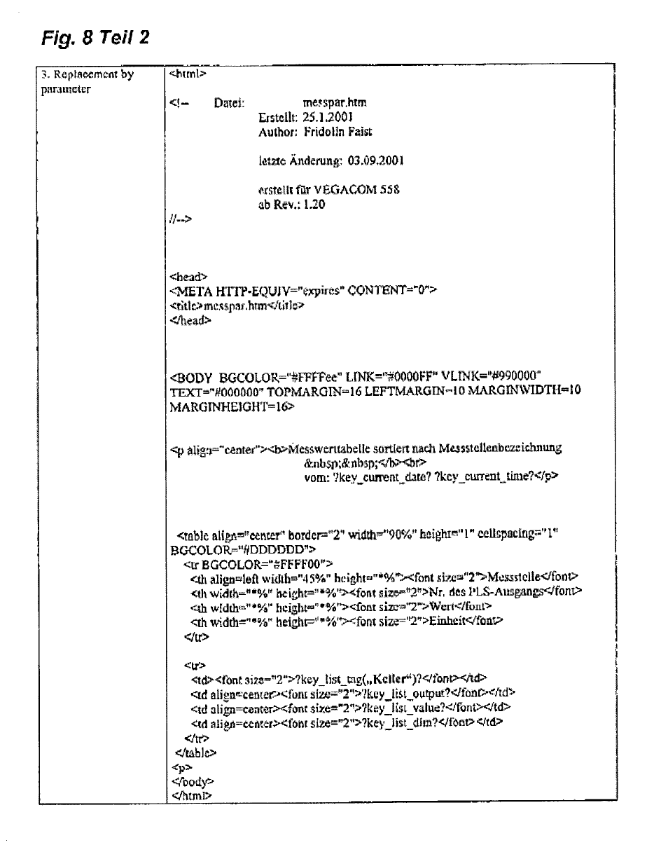

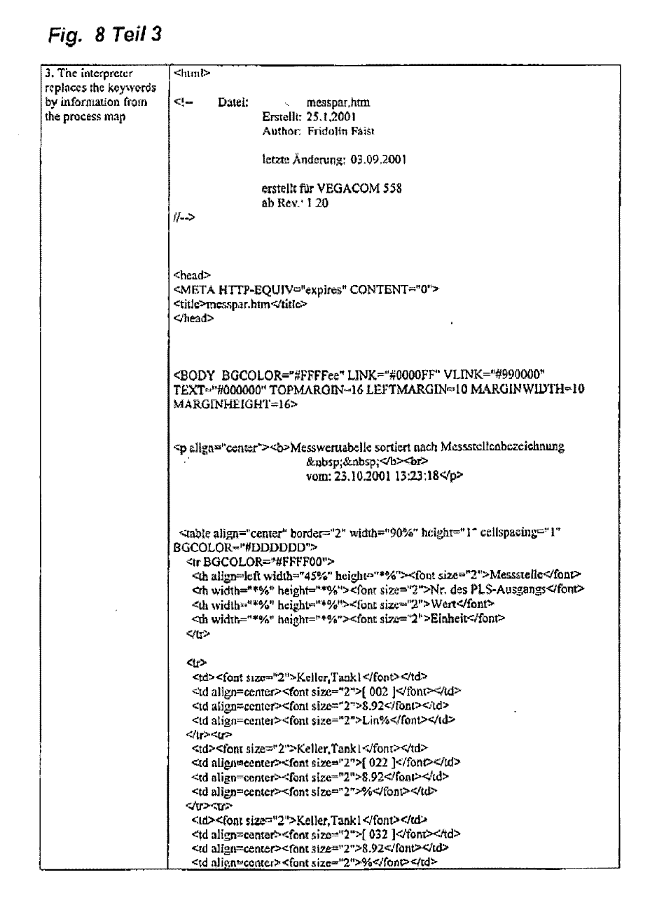

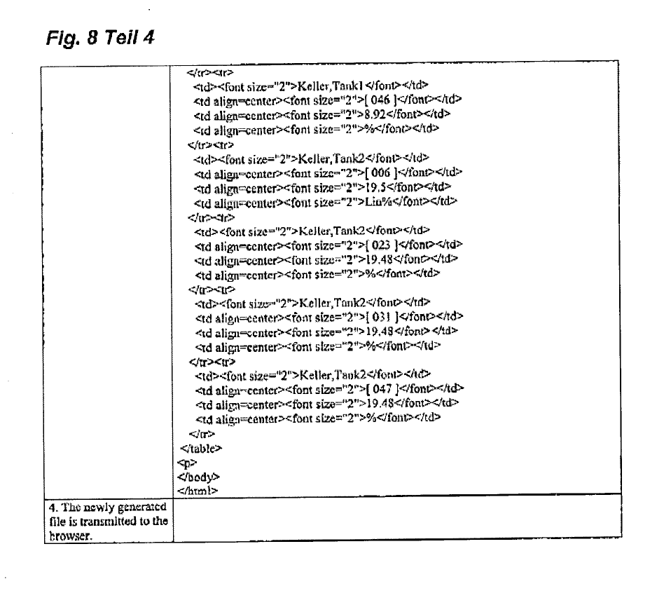

This is again illustrated in detail in FIG. 8 including the parts 1 through 4. As can be seen here, the browser invokes the file “messw.htm” adding the parameter 1=“Keller” (“basement”). The wildcard “parameter 1” is contained in the stored template. In step 3, the parameter replacement now takes place, i.e. the wildcard “parameter 1” will be replaced by the corresponding parameter value “Keller” (“basement”).

Then, the replacement of the keywords by information from the process map takes place in the above explained manner (step 3) using the interpreter. This newly generated HTML file is then transmitted to the browser.

The representation on the monitor of this newly transmitted HTML file is shown in FIG. 9.

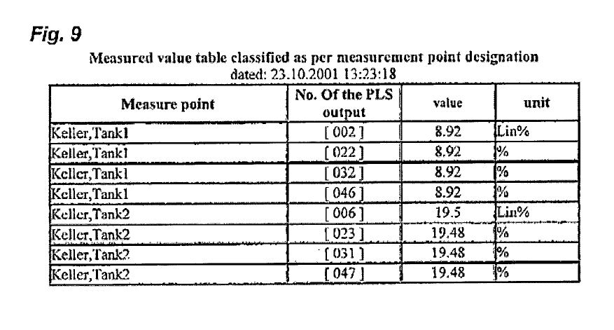

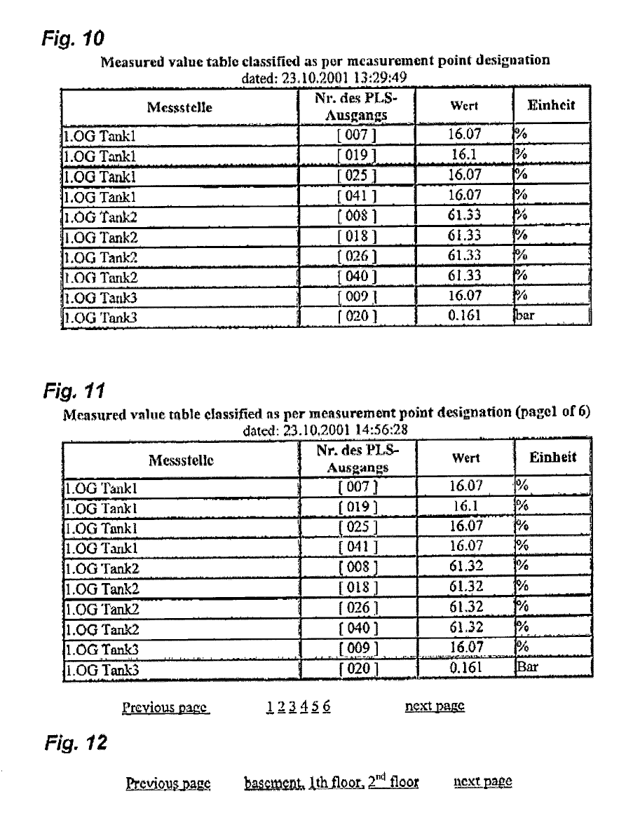

If now instead of the request of the browser shown in FIG. 8, having the parameter value “Keller” (“basement”) as parameter 1, the parameter value “1. OG” (“1st floor”) is set, another data set will be displayed, however, still based on the same stored template. The representation of this modified data set is shown in FIG. 10.

It is hence possible to generate by this method of replacing wildcards almost any desired number of web pages with only one single stored template. In the above described VEGAMET device, no more than three templates would have to be stored in three different languages for the maximum expansion of 15 devices. This in turn results in a storage requirement of about 6 KByte. Therewith, the storage requirement is considerably reduced.

If it is in addition provided that in the stored HTML template the keyword ?key_nav_control? is inserted, then a navigation bar will herewith be built up, which based on the current system configurations, dynamically enables the various pages to be called. According to the currently existing number of measurement points, a navigation bar with n pages will be offered. This is illustrated in FIG. 11.

In this approach, as well, the navigation bar can be modified in that as the parameter value for the keyword ?key_nav_control?, another parameter value is transmitted, e.g. “Keller” (“basement”), “1. OG” (1^{st} floor”), “2. OG” (2^{nd} floor). Therewith, a new navigation bar will then be generated such as it is illustrated in FIG. 12.

Hence, it is also possible to build up new navigation bars, these navigation bars being user-definable.

Basically, a web server is present in the device. In particular, this is an interpreting web server. Same is for example able to interpret certain keywords and to replace them by current values with the request of such a web page. The keywords mentioned here are supposed to not only replace a simple element, but also to recognize with the presence of repeating structures, such as, for example, several measurement points in task processing systems, how many of these structures are given and to automatically generate tables accordingly.

Example: In an HTML template, the term ?key_list-tag(Par1)? is used in a table structure, and the HTML page is called messwerte.htm (measurementvalues.htm). When the page is called with messwerte.htm?Par1⁻“a”-“b”, then a copy of the HTML template is first loaded into the RAM. With this copy, the following processing steps will be performed. Next, the device-inherent web server checks whether the term “Par1” exists in the HTML page. If yes, “Par1” will be replaced by “a”-“b”. Now ensues the generation of the table with consideration of the transmitted parameters and sending the obtained content to the web browser.

In HTML templates, several tables with different keywords and in each case with different “wildcards” can to be used. Even several wildcards can be used within the range limitation field, e.g. ?key_list_tag(Par1, Par2, Par3)?.

The advantage of this variant has to be seen in that only a few templates are necessary for any desired number of representation variants, that storage space is saved, the work expenditure during the establishment of web pages (web design) is decreased, the maintenance expenditure is reduced and therewith, overall costs are saved.

For completeness' sake, more details as to the keywords are given in the following:

Measurement point-related keywords

Display single values

Keywords for single information

| | |
|---|---|
| ?key_tag[x]? | display of the measurement point |
| | identifier (TAG name) |
| ?key_output[x]? | Display of the measurement point |
| | number |
| ?key_value[x]? | Display of the measured value |
| ?key_dim[x]? | Display of the measurement point unit |

The identifier [x] indicates for which measurement point the replacement is supposed to take place. Possible values are here [1] through [255] for the measurement point number 1 through 255 in the VEGALOG, or

[1.1] through [15.7] for the VEGAMET devices 1 through 15 and the associated measurement points 1 through 7.

Display Lists

Keywords for lists or tables

| | |
|---|---|
| ?key_list_tag? | Display of the measurement point identifier |
| | (TAG name) |
| ?key_list_output? | Display of the measurement point number |
| ?key_list_value? | Display of the measured value |
| ?key_list_dim? | Display of the measurement point unit |

The above-mentioned keywords generate a list of all existing values. The first occurrence of the keyword ?key_list_tag? or ?key_list_output? determines the sorting sequence for the table (TAG name or measurement point number).

Range Limitation

The range limitation takes place by indicating the range in round brackets directly after the keyword.

Keywords for lists or tables

| | |
|---|---|
| ?key_list_tag(“a”-“f”, “Keller”) | Display of the measurement point |
| | identifier (TAG name) |
| ?key_list_output(“a”-“f”, “Keller”) | Display of the measurement point |
| | number |

Other Keywords

| | |
|---|---|
| ?key_serno[x]? | Serial number of the device |
| ?key_list_serno? | list of all serial numbers |
| ?key_type[x]? | Device type |
| ?key_list_type? | list of all device types |
| ?key_version[x]? | Device version |
| ?key_list_version? | list of all device versions |

General Keywords

| | |
|---|---|
| ?key_current_date? | Current date |
| ?key_current_time? | Current time |

### General Description “Interpreter”

A system used here, as it is, for example, shown in FIG. 13, comprises a PC 10 that is connected with an internetable device 23 (e.g. a small SPS, control unit) via an interface 3. The system moreover comprises a plurality of sensors 14 and actuators 15 communicating bidirectionally with the internetable device 23 via a bus system 5. The interface 3 is a point-to-point connection and therefore not bus-capable. The interface 3 is usually the parametrization interface for producer-specific programming tools. The inventive method can be implemented in the device 23.

FIG. 14 shows the components of the PC 10 and the device 23 essential in this context in the case where the device 23 is provided with a web server functionality according to the state of the art, i.e. that it comprises an Internet browser based on “hard-coded” web pages.

The PC 10 accordingly includes a user software 101, and a web browser 102, both connected with the interface 3 via a first network driver 103. On the side of the device 23, a second network driver 131 is present connected to the interface 3. With the second network driver 131, a communication software 132 and a web server 133 are connected, which also communicate with each other. The signals transmitted via the bus system 4 to and from the sensors 14 and actuators 15 are guided over a unit 135 for signal, measured value and task processing. This unit is in turn connected with a memory 134 for measured values and data, to which the communication software 132 accesses. Via all of these connections in the PC 10 and the device 23, the data can be transmitted in both directions.

As already mentioned at the beginning, it is, however, disadvantageous that the structure of the web pages which can be called in this way, is fixedly stored in the devices, and only some of the information reflecting the status of the devices can be dynamically inserted when calling the pages.

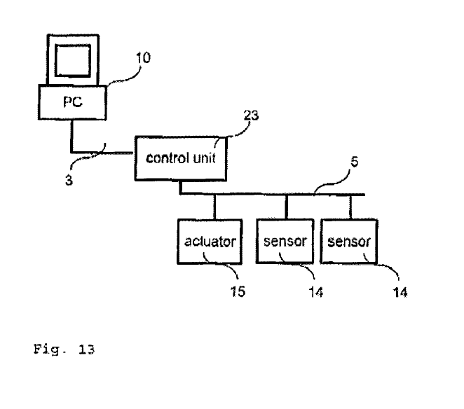

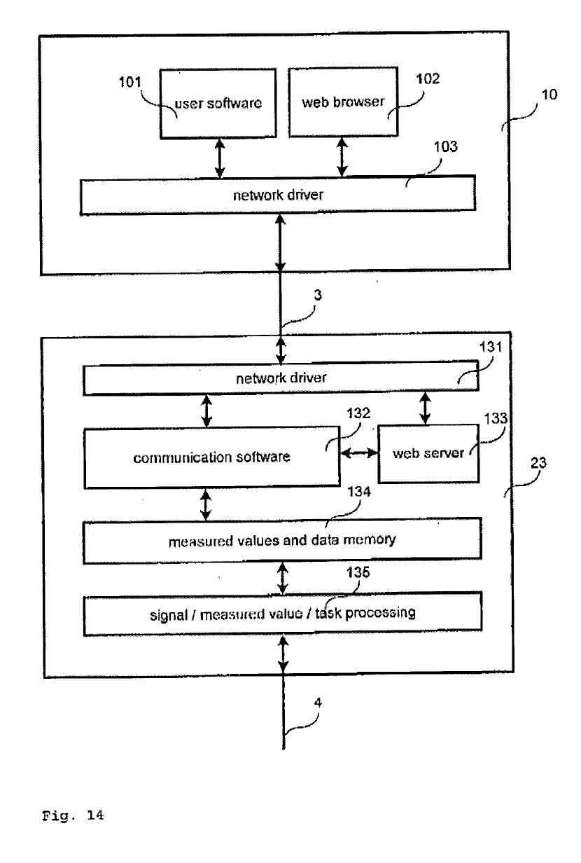

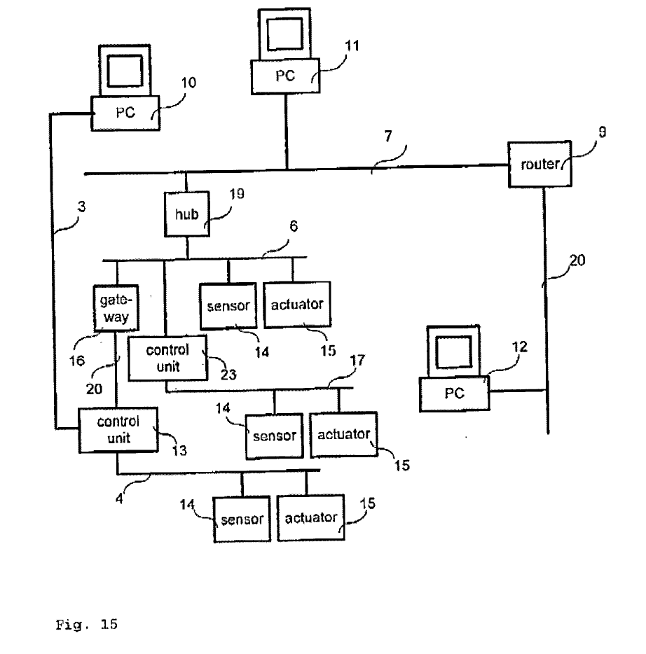

FIG. 15, on the other hand, shows a schematic representation of a first inventive embodiment of a task processing system. This system comprises a first PC 10, a second PC 11, and a third PC 12, which can be situated in any desired geographical locations. The first PC 10 is thereby connected with a first control unit 13 via an interface 3, which control unit can, for example, be an SPS, a PLS, a remote I/O unit or an intelligent bus terminal. The first control unit 13 is connected via a first field bus 21 on the process level (e.g. ProfiBusDP, Interbus, etc., or a proprietary solution) with a gateway 16, through which a connection to a first local network 6 (LAN—local area network) can be established, which is a bus system on the automation level (e.g. Ethernet, Token Ring, etc.).

The first control unit moreover is connected via a second bus 4 with a plurality of sensors 14 and actuators 15. The second bus 4, which is constituted by control lines, which optionally can also guide bidirectional signals, can be a field bus on the field level (e.g. ASI) or can comprise analog inputs and outputs with 4 through 20 mA, and switching inputs and outputs.

Via the first local network 6, a communication with further sensors 14 and actuators 15, as well as a second control unit 23 arranged still further remote (e.g. an SPS, a PLS, a remote I/O unit or an intelligent bus terminal) can take place, which is connected via a third field bus 5 on the field level (e.g. ProfibusPA, FielbusFoundation, etc., or a proprietary solution) with further sensors 14 and actuators 15.

The second PC 11 in this system is connected via a second local network (LAN) 7. This second network 7 is connected via a router 9 with a third supraregional network (WAN—wide area network) 20, to which the third PC 12 is connected. The second network 7 is moreover connected via a HUB 19 with the first local network 6.

The components of the first, second and third PC 10, 11, 12, and of the first and second control unit 13, 23, which are essential in this context, are shown in FIG. 16.

The PCs each comprise a user software 101, a web browser 102, and other Internet services 104, which are connected with a first interface driver 105 for bidirectional communication. This first interface driver 105 establishes a connection towards the outside via the interface 3, the second local network 7 or the supraregional network 20.

The first and second control units 13, 23 each comprise at the input a second interface driver 136, which is connected via the interface 3 with the first PC 10, or via the first local network 6, the HUB 19 and the second local network 7 with the second PC 11, and further via the router 9 and the third supraregional network 20 with the third PC 12.

Within the control unit, the second interface driver 136 is in each case in bidirectional communication with a communication software 132, an Internet server 133 and an FTP-Client/Server 137. The control unit moreover comprises a memory 134 for measured values and data, communicating bidirectionally with the communication software 132, as well as a processing unit 135 for signals, measured values and processes. The unit 135 is connected with the second and third bus, 4, 5, respectively, which enables a bidirectional communication with the sensors 14 and the actuators 15.

The control unit 13, 23 moreover comprises an Internet page generator 139 capable of providing any desired layouts (templates) with current values, and being in each case in bidirectional connection with the Internet server 133, the memory 134 for measured values and data, as well as the memory 138 for any desired templates of Internet pages. The memory 138 is in bidirectional connection with the FTP-Client/Server 137 and a non-volatile memory 43 that is also used for storing any desired templates and comprises on its part a bidirectional connection with the communication software 132.

The Internet pages generated by the generator 139 are supplied to the web server 133, which is connected with the second interface driver 136. The memory 138 thereby does not only store templates and layouts, but also manages these in a RAMDISK wherein the same format is used as in a RAMDISK or hard disk of the PC. Thus, copying, erasing, shifting and generating of files and folders becomes very simple with the tools generally used in the prior art PC domain.

All connections within the PCs 10, 11, 12 and the control units 13, 23 enable a bidirectional communication between the linked units.

In this embodiment, the sensors 14, actuators 15 and control units 13, 23 are digitally communicating devices which are interconnected via the mentioned networks 7, 20 (LAN, WAN) and routers 9, respectively, so that they can be situated at any desired location. The devices form task processing, networked systems supporting Internet protocols and Internet services and comprising the non-volatile memory 43, in which simple HTML files and graphics concerning the running time can be stored.

FIG. 17 schematically shows a part of a second inventive embodiment of a task processing system. In contrast to the first embodiment, the first and second control unit 13, 23 here are combined and commonly connected with the first PC 10 via the interface 3. Furthermore, the two control units communicate commonly with the components shown in FIG. 3 via the first local network 6 and the first field bus 21, and are connected with the sensors 14 and the actuators 15 via the third field bus 5.

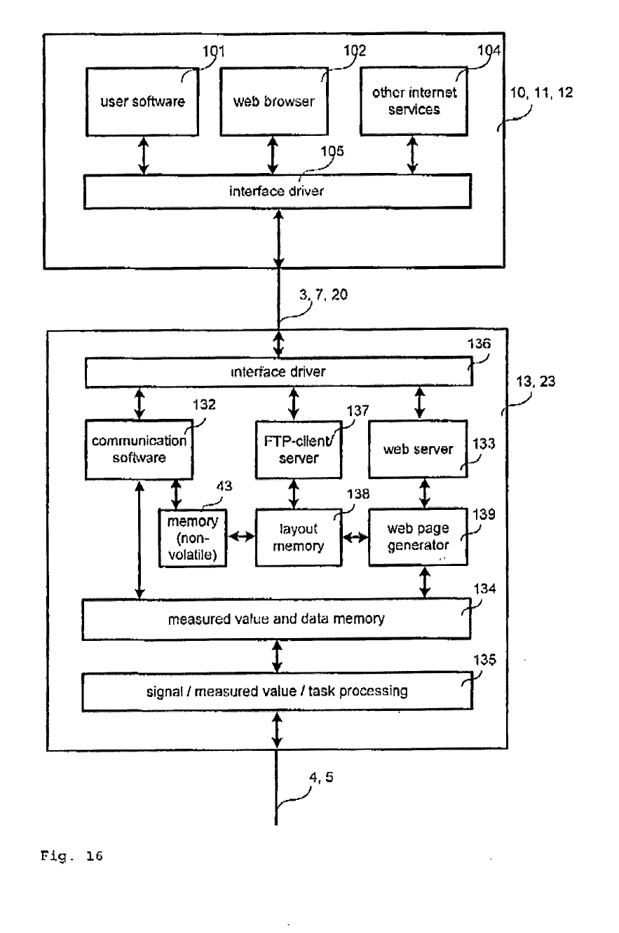

FIG. 18 schematically shows a part of a third inventive embodiment of a task processing system. Here, in contrast to the first embodiment, the gateway 16 is directly connected with the first PC 10 via the interface 3. To the gateway 16 follows in turn the first local network 6 and the first field bus 21, which is connected with the first control unit 13. Same, in turn, communicates with the sensors 14 and actuators 15 via the second bus 4.

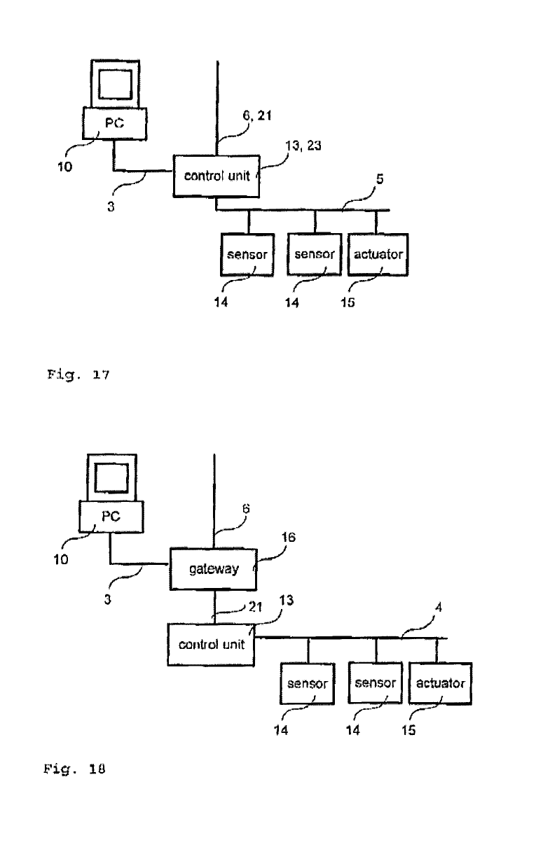

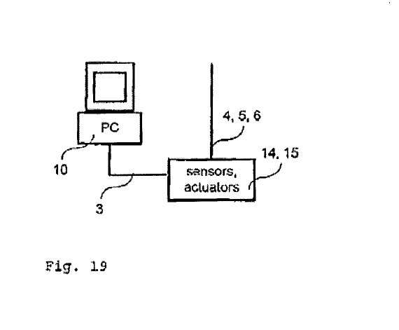

In the part of a fourth inventive embodiment schematically shown in FIG. 19, the first PC 10 is finally directly connected via the interface 3 with the sensors 14 and actuators 15. These in turn communicate as it is the case in the first embodiment as per FIG. 15, with the respective components via the second bus 4, the third field bus 5 and the local network 6.

The structure, configuration and texturing of these pages can be carried out by an operator of the system on one of the PCs in any desired manner, and is individually transmitted into the separate devices prior to or during the ongoing operation of the system. Certain passages on these pages which are intended to contain status information on process variables or process parameters, can now be marked according to one or more aspect/s of the invention—as already described before—via defined keywords. The operator of the system therewith has the possibility of creating an interface to his devices by selecting appropriate graphic elements corresponding, for example, to certain in-house representation forms. Moreover, he can influence the content of the pages so that only the contents of interest to him will appear. The thus established client-specific files can be transmitted with the usual Internet services (FTP transfer) via the described networks (LAN, WAN) and bus systems, or over any other interface present on the device, to the devices where they will then be stored in a non-volatile manner.

Insofar as the devices find contents in the memory areas intended for that purpose, these contents will be automatically interpreted and converted by the web page generator 139 into new HTML pages, which exactly consider the representation forms of the templates. If necessary, the keywords in the newly generated HTML pages will be replaced by corresponding current information. Constructs built up in a table or list form, for example, for indicating process variables, therewith have only to be plotted once in the template. The respective devices will automatically expand these constructions, if the case may be, by the number of the existing process variables.

In addition to the layout for a message, second layouts can be stored containing pure list or table constructs. These second layouts use simple file formats suitable for being further processed in task processing systems and which are enclosed in the message in the form of an attachment.

The thus configured devices enable the user to realize individual representation forms for information pages or operating elements with simple and generally available means in a cost-efficient manner and using the HTML pages as the layout, which can be called via a conventional web browser. The information pages mentioned here can contain information on the system itself, as well as indications as to the operational state and measured values of the process variable. The thus configured devices of the system offer the possibility of realizing a continuous adaptation to new circumstances throughout the whole life time of the system.

In order to avoid problems, which possibly could arise due to storing defective HTML pages in the devices, these devices are delivered with prefabricated pages, which cannot be manipulated by the operator of the system. Depending on the fact with which URL (Uniform Resource Locator) address the system user addresses the devices during the call of the web browser, it is selectively commutated within the device between the reproduction of pages which had been delivered with the devices, and the client-specific pages. The user, however, is also allowed to store a plurality of various pages, i.e. over a plurality of different URLs, a different information content can in each case be requested.

Therewith, it is secured that the information made available in the device can be requested at any moment.

This method, by means of which Internet pages of devices in task processing system can be individually modified during the execution time, can also be transferred to other Internet services. Thus, for example, templates for fax letters or e-mails can likewise be stored in these devices, which will only be dispatched upon occurrence of certain events. Such events can, for example, be the excess of determined measured values, the generation of fault alarms in the system or the obtainment of determined process states. For the mentioned fax or e-mail templates, it likewise applies that they can be provided with keywords which will be replaced by the device by current values when the templates are being dispatched.

For certain applications, it is, for example, interesting to attach to the e-mails determined files, which are generated in the devices themselves. These files can, for example be pure ASCII files containing measured value records of the system in a table form. One of the advantages of the transmission per e-mail consists in that such messages can be forwarded to any addressee without an approval of a system administrator.

A further possibility consists in automatically dispatching data at determined times to certain servers, e.g. process control computers. An FTP client is preferably realized in the here described devices for this service. This FTP client is able to autonomously establish an FTP connection to a server (process control computer) by means of the configurations stored in the device, to subsequently transmit the files, and to finally dismantle the connection.

A further application of the invention is constituted by the flexible adaptation of a user surface for the described devices. Instead of the hitherto mentioned information pages, process variables can as well be changed via the HTTP. Moreover, not only pure HTML tags, but also Java scripts and CGIs (Common Gateway Interface) can be used for the individual design of the web page of these devices.

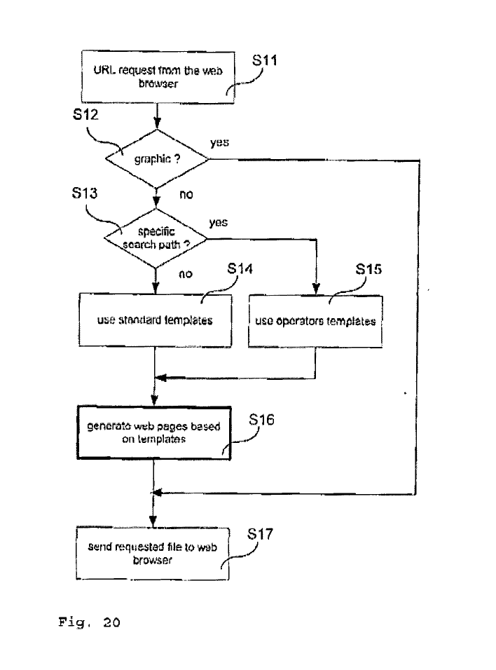

By means of the flow chart in FIG. 20, the sequence of operations will now be explained in an exemplary manner, which takes place for the selection of an access path for templates with user inputs via an Internet browser.

In a step S11, the Internet browser requests a file via an Internet address (URL). In a step S12, it is then inquired whether the requested file is a graphic. When this is not the case, and when according to the inquiry of step S 13, a specific search path is not indicated either, the templates from the standard layouts will be used according to step S14, and the internet pages will be generated according to step S116 based on these templates. Subsequently, the generated and requested file will be sent to the Internet browser transmitting the request according to step S17.

If, according to the inquiry of step S 12, a graphic is required, then this will be transmitted to the Internet browser according to step S17. If, according to the inquiry of step S 13, a specific search path is indicated, the templates of the user will be utilized according to step S 15, and the Internet pages will be generated according to step S 16 and transmitted according to step S17.

FIG. 21 shows a flow chart of the generation of web pages on the basis of templates, whereby keywords are replaced and list or tables are dynamically expanded in dependence on existing process maps or a device configuration. FIG. 21 also shows the basic process steps in the generation of event messages, e-mails and measured value records, whereby for table constructs in the layouts thereof, likewise the syntax for HTML pages is used.

In a step S21, the respective file will first be opened, the access pointer being set to “start”. According to step S22, a next keyword will be searched. When a keyword has been found according to the inquiry in step S23, it will be inquired according to step S24 whether it is within the HTML tags for lists or tables. If this is the case, a subsequent configured element will be searched in the process map according to step S25. When such an element has been found according to the inquiry in step S27, the list or table will be expanded by one line, and the contained keywords of the line will be replaced by values of the element. Subsequently, this process step will be repeated by returning to step S25.

If no further element is found during the search for the next configured element in the process map according to step S25 and the inquiry according to step S27, the access pointer will be corrected to “end” of the inserted values according to step S29, and the process will be repeated by returning to step S22 (search for the next keyword).

If according to step S23, a keyword is not found, the process is terminated according to step S30. If, however, a keyword is found, but same is not within the HTML tags for lists and tables according to the inquiry in step S24, the keyword will be replaced according to step S26 by a current value such as a measured value, a parameter, etc., and it will subsequently be continued with step S29 (correct access pointer to “end” of the inserted values), for finally repeating the process and the search for a next keyword with step 22.

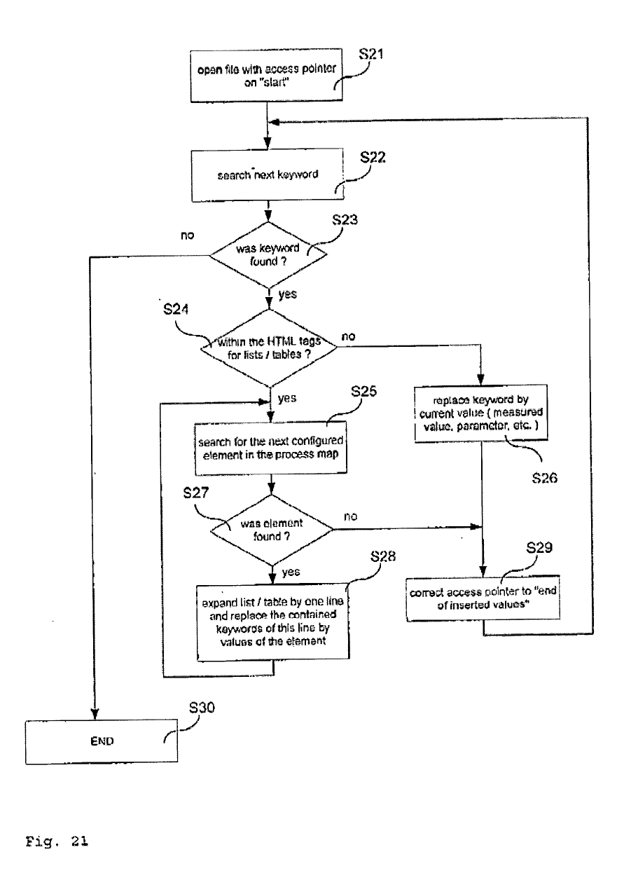

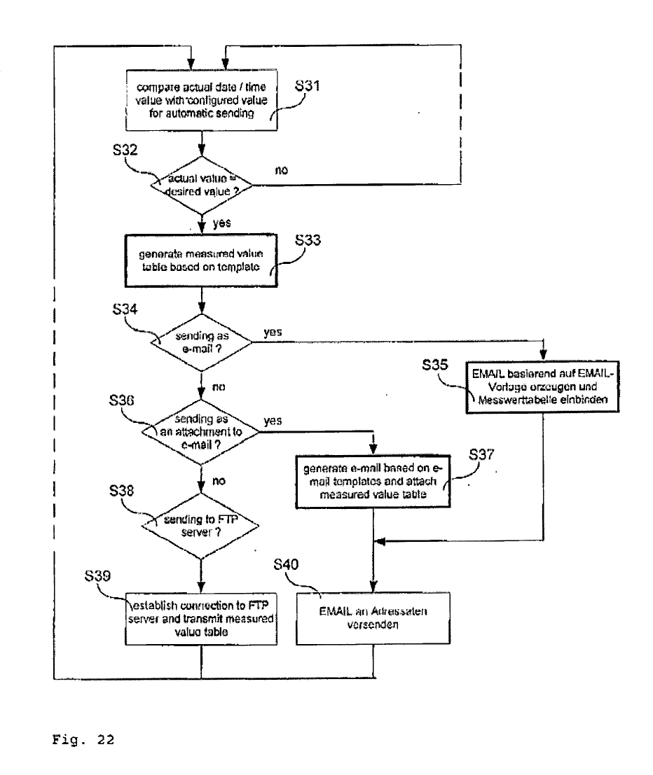

Finally, FIG. 22 shows a flow chart of dispatching information according to pre-configured time criteria, that means according to fixed time intervals or programmable fixed times. For this purpose, the actual value of date and time is first compared according to step S31 with corresponding configured desired values for an automatic sending. If, according to step S32, the actual value is equal to the desired value, then a measured value table is generated based on the templates according to step S33. Subsequently, it is inquired according to step S 34 whether the dispatch is supposed to take place as an e-mail. If this is the case, an e-mail will be generated on the basis of e-mail layouts according to step S35, and the measured value table will be enclosed accordingly. Then, the e-mail will be sent to the addressee according to step S40, and the process will be repeated by returning to step S31.

If the inquiry according to step S34 is answered with “No”, it is inquired according to step S36 whether the dispatch is supposed to take place as an attachment to an e-mail. If this is the case, an e-mail will be generated based on e-mail layouts, and the measured value table will be enclosed as an attachment. Subsequently, the e-mail will be sent to the addressee according to step S40, and the process will be repeated by returning to step S31. If the inquiry according to step S36 is answered with “No”, it is inquired according to step S38 whether the dispatch is supposed to take place to an FTP server. If this inquiry is answered with “Yes”, a connection to the corresponding FTP server will be established according to step S39, and the measured value table will be transmitted. Subsequently, the process can be repeated by returning to step S31.

Even with the focus of the access possibilities substantially residing in the use of PCs in the above description, which communicate or exchange data via one of the mentioned networks through Internet services, the presence of such a network, however, is not at all compulsory. The data exchange with the PCs may, on the contrary, be realized via any other interface directly between the process devices (i.e. sensors, actuators, gateways, control units) and the PCs. Moreover, the PCs may also be connected to bus systems via which Internet protocols are not typically transmitted.

1. A web page template,
defined in a page description language,
storable on a web server, and
containing at least one wildcard,
the wildcard having to be replaced by a parameter,
the parameter being transmitted by means of a web browser along with a request of the web page based on the template, and being definable by a user, and
containing at least one keyword that has to be replaced by data from a process map, various representations of the web page based on the invoked template and adapted to the user's requirements being able to be generated with current data by means of only one stored template.

2. The web page template according to claim 1, the template being stored on the web server of a process device.

3. The web page template according to claim 2, the template being stored on a process
device having a device-inherent web server, which process device is selected from the group comprised of level measuring device, pressure measuring device, limit switch, field device, sensor, actuator, flow rate measuring device, interface converter.

4. The web page template according to claim 1, several different wildcards being present in the template, and a parameter comprising a parameter name and an associated parameter value, and in all places where the wildcard is identical with the parameter name in the template requested by the web browser, the wildcard has to be replaced by the parameter value associated with the respective parameter name, and several keywords being present which have to be replaced by current process data.

5. The web page template according to claim 1, the data from the process map being current process values.

6. The web page template according to claim 1, the data from the process map being current measured values.

7. The web page template according to claim 1, a parameter having an influence on the representation of the navigation bar of the invoked web page.

8. The web page template according to claim 1, the template being an HTML file.

9. An template for one or several web pages,
defined in a page description language,
storable on a web server,
containing several wildcards, and
containing several keywords,
parameter names definable by a user, which have in each case a parameter value assigned, being transmitted along with the web page request by means of a web browser, and in all places where the wildcard is identical with the parameter name in the template requested by the web browser, the wildcard has to be replaced by the parameter value associated with the respective parameter name, and
the keywords having to be replaced by current data, so that based on a single template, user-defined representations of the web pages can be represented on a display with current information.

10. A process device, comprising a web server including a data memory, in which a number of web page templates defined in a page description language are stored,
in each case several wildcards and several keywords being present in the web page templates,
parameter names definable by a user and having each a parameter value assigned, being transmitted along with the web page request by means of a web browser, and in all places where the wildcard is identical with the parameter name in the template requested by the web browser, the wildcard has to be replaced by the parameter value associated with the respective parameter name, and
the keywords having to be replaced by assigned current data, so that based on a single template, user-defined representations of the web pages can be represented on a display with current information.

11. The process device according to claim 10, the web server being able to be connected via a data connection with the web browser to be operated by a user.

12. The process device according to claim 10, the process device being selected from the group comprised of level measuring device, pressure measuring device, limit switch, field device, sensor, actuator, flow rate measuring device, interface converter, which have a device-inherent web server.

13. A web page template defined in a page description language and storable on a web server, and containing at least one wildcard to be replaced by a parameter, the parameter being transmitted by means of a web browser along with the request of the web page based on the template and being user-definable, whereby with only one stored template, different representations adapted to the user's requirements can be generated of the web pages based on the invoked template.

14. The web page template according to claim 13, the template being stored on the web
server of the process device.

15. The web page template according to claim 14, the template being stored on a process
device including a device-inherent web server, which process device is selected from the group comprised of level measuring device, pressure measuring device, limit switch, field device, sensor, actuator, flow rate measuring device, interface converter.

16. The web page template according to claim 13, several different wildcards being present in the template, and a parameter comprising a parameter name and an associated parameter value, and in all places where the wildcard is identical with the parameter name in the template requested by the web browser, the wildcard has to be replaced by the parameter value associated with the respective parameter name.

17. The web page template according to claim 13, the template being an HTML file.

18. The web page template according to claim 13, the stored template moreover containing so-called keywords to be replaced by information from a process map.

19. The web page template according to claim 18, the information from the process map being current process values.

20. The web page template according to claim 18, the information from the process map being current measured values.

21. The web page template according to claim 13, a parameter having an influence on the representation and function of a navigation bar of the invoked web page.

22. A template for one or several web pages,
defined in a page description language,
storable on a web server,
containing several wildcards each to be replaced by a determined parameter value,
parameter names selected by a user, which have in each case a parameter value assigned, being transmitted along with the web page request by means of a web browser, and in all places where the wildcard is identical with the parameter name in the template requested by the web browser, said wildcard has to be replaced by the parameter value associated with the respective parameter name.

23. The template according to claim 22, the template being stored on a process device including a device-inherent web server, which process device is selected from the group comprised of level measuring device, pressure measuring device, limit switch, field device, sensor, actuator, flow rate measuring device, interface converter.

24. A process device, comprising a web server including a data memory, in which a number of web page templates defined in a page description language are stored for one or several web page/s,
one or several of the templates including at least one wildcard to be replaced by a parameter transmitted along with the request of the web page by means of the web browser and being user-selectable, whereby with a single stored template, different representations of the web page based on the invoked template adapted to the user's requirements can be generated.

25. The process device according to claim 22, the web server being connectable via a data connection with the web browser to be operated by a user.

26. The process device according to claim 25, the process device being selected from the group comprised of level measuring device, pressure measuring device, limit switch, field device, sensor, actuator, flow rate measuring device, interface converter.

27. A web page template
defined in a page description language,
storable on a web server, and
containing at least one keyword, which is assigned current data after calling the web page, whereby the web page based on the invoked template is represented with current data.

28. The template according to claim 27, the template being stored on the web server of a process device.

29. The template according to claim 27, the template being stored on a process device including a device-inherent web server, which process device is selected from the group comprised of level measuring device, pressure measuring device, limit switch, field device, sensor, actuator, flow rate measuring device, interface converter.

30. The template according to claim 27, the data being current process data.

31. The template according to claim 27, the data being current measured values.

32. A process device, comprising a web server including a data memory, in which a number of templates defined in a page description language are stored for one or several web pages,
one or several of the templates containing at least one keyword, which is assigned current data by a web browser after calling the web page, whereby the web page based on the invoked template is represented with current data.

33. The process device according to claim 32, the process device being selected from the group comprised of level measuring device, pressure measuring device, limit switch, field device, sensor, actuator, flow rate measuring device, interface converter.

34. A method for calling a web page, comprising
the establishment of a connection to a web server via a web browser, at least one web page template defined in a page description language and containing at least one wildcard being stored on the web server,
the call of a web page template by means of the web browser,
the transferal of a parameter value with the web page call, the transferred parameter value representing a representation of a stored template desired by the user,
the replacement of the wildcards in the invoked web page templates by the parameter value, whereby the web page template is modified according to the user's requirements; and
the transferal of the modified template to the web browser.

35. The method according to claim 34, the step of representing the web page on a display taking place subsequent to the transmission of the newly generated template according
to the modified web page template.

36. The method according to claim 34, the web page template containing several different wildcards, and a parameter consisting of parameter name and parameter value, and several parameters being transferred with the call of a web page template, and in all places where a wildcard is identical with a parameter name, the wildcard will be replaced in the web page template requested by the web browser by a corresponding transferred parameter value.

37. The method according to claim 36, the parameter values being pre-definable by the
user.

38. The method according to claim 34, the web page template being an HTML file.

39. The method according to claim 34, the stored template also containing so-called keywords, which will be replaced by current data from a process map.

40. The method according to claim 39, the data being current process or measured values.

41. The method according to claim 39, the replacement of the keywords by the current data taking place by means of an interpreter.

42. The method according to claim 31, the replacement of the keywords by current data taking place subsequent to wildcards being replaced in the modified template by transferred parameter values.

43. The method according to claim 34, the web server being connected via a data connection with the web browser to be operated by a user.

44. The method according to claim 34, one or several parameters being transferred having an influence on the representation and function of the navigation bar.

45. A method for adapting a process device comprising a web server and a data memory, to the requirements of a user, the communication with the process device taking place via a data telecommunication, including the following process steps:
making available a web page template defined in a page description language,
sending said web page template via a data telecommunication to the process device, and
storing said web page template on the data memory of the web server in the process device.

46. The method according to claim 45, the transmission of the web page template to the
process device taking place via an Ethernet or the Internet.

47. The method according to claim 46, the transmission and the storage of a web page template on the data memory of the process device taking place by means of a standard tool.

48. The method according to claim 47, the standard tool being a web browser.

49. The method according to claim 47, the standard tool being an FTP browser.

50. The method according to claim 48, the web browser including for the user on a display screen, a two-part graphical user surface, the one part of the user surface representing a user terminal, the other part of the user surface representing the process device, and the selected web page template being transmitted to and stored in the process device by “drag and drop”.

51. The method according to claim 45, the web page template stored on the data memory of the web server of the process device being used for generating a web page representing current data.

52. The method according to claim 46, the stored web page template being used as the layout when e-mails are sent and/or FTP files are sent via FTP client services.

53. The method according to claim 46, the stored web page template being used as the layout for answering a request by a remote Internet browser or with the occurrence of predefined events.

54. The method according to claim 45, the web page template being an HTML file.

55. The method according to claim 45, the transmission of the web page template into the process device taking place during the running operation of the process device.

56. The method according to claim 45, a standard operator control surface or an adapted operator control surface being able to be selectively activated by selecting an addressing.

57. The method according to claim 56, diagnostic aids for malfunctions occurring in the adapted user surface being made available via the standard operator control surface.

58. The method according to claim 45, the templates for the adapted Internet pages, the adapted e-mails and the measured value protocols, respectively, containing keywords, which are assigned current data when requests of a remote Internet browser are answered.

59. The method according to claim 45, specific keywords being provided for HTML constructs such as lists and tables, which keywords are entered in the layout and are automatically reproduced in the device during the execution time, the reproduction taking place according to the number of pieces of present information or of process variables explicitly listed in the keyword.

60. The method according to claim 45, the sending of e-mails for adapting event messages and/or of FTP files for adapting measured value protocols being automatically released by events such as reaching or exceeding predetermined measured values, the occurrence of predetermined status messages such as faults, process state and such like.

61. The method according to claim 45, the sending of e-mails for adapting event messages and/or of FTP files for adapting measure value protocols being released cyclically at predefined fixed time intervals or at predefined times, in dependence on the configurations realized.

62. A system for representing user-defined web pages, comprising
a user terminal including a data input means and a web page representation means for displaying web pages,
at least one process device having a data memory and being connected with the user terminal via a data telecommunication,
at least one web page template defined in a page description language being stored on the data memory of the process device,
the stored web page template containing at least one wildcard and several keywords,
parameter names definable by a user via the data input means, which parameter names each have a parameter value assigned, being transmitted along with a web page request by means of a web browser via the data telecommunication, and in all places where in the template requested by the web browser, a wildcard is identical with a parameter name, said wildcard will be replaced by the parameter value associated with said parameter name, and
the keywords being replaced by current data, so that based on a single template, user-defined representations of the web pages are displayed with current information on the web page representation means.

63. The system according to claim 62, the process device comprising an Internet server, an Internet page generator, a layout memory for Internet pages, FTP client/server units, and at least one interface suited for digital communication.

64. The system according to claim 62, the process device comprising at least one interface suited for digital communication, means for processing Internet protocols and Internet services, such as for the communication via Internet browsers, e-mail services and/or FTP client services, as well as means for storing files with standard tools as templates in a file system, and for additionally saving in a non-volatile storage area.

65. The system according to claim 62, the digital interface for importing the file templates and the interface for interconnecting the devices being identical.

66. The system according to claim 62, a separate interface being provided for importing the file templates.
